(19) United States
(12) Patent Application Publication
(10) Pub. No.: US 2025/0389362 A1
(43) Pub. Date: Dec. 25, 2025

(54) POTTED CAVITY FITTING

(71) Applicant: GOODRICH CORPORATION, Charlotte, NC (US)

(72) Inventors: Nathaniel Ching, Hartville, OH (US); Jin Hu, Cary, NC (US); Casey M Slane, Tallmadge, OH (US)

(73) Assignee: GOODRICH CORPORATION, Charlotte, NC (US)

(21) Appl. No.: 18/752,491

(22) Filed: Jun. 24, 2024

(51) Int. Cl. F16L 47/02; F16L 55/163; F16L 55/164

(52) U.S. Cl. CPC F16L 47/02; F16L 13/116; F16L 13/10

(57) ABSTRACT

A potted cavity fitting. The potted cavity fitting includes a fitting, a first cavity configured within the fitting, and a second cavity configured within the fitting. The fitting is configured to receive an end of a tube and a portion from the end of the tube. The first cavity is configured to retain a first mechanism the prevent or reduce liquid from passing through. The second cavity is configured to retain a second mechanism at least one of coupled to or formed within the tube.

### FIELD

The present disclosure relates to fittings for fluid systems, and more specifically, to a potted cavity fitting.

### BACKGROUND

Aircrafts have many metallic components, i.e., valves, bulkheads, etc., with standard metallic tubing and couplings, also referred to as fittings. The metallic fittings are designed for high strength and low creep of the metals utilized in the fittings. That is, many existing metallic fittings rely on the strength of metal to hold together under stress. Plastic tubing is lighter and less expensive than metallic tubing; however, plastic tubing does not have a strength or creep resistance to be formed so as to interface with standard metallic fittings. Moreover, because of differing coefficients of thermal expansion (CTE), plastic and metal tubing may not be directly bonded together because the bond may be subject to stresses greater than the strength of most adhesives. Furthermore, most adhesives are not approved for use with potable water and may contaminate the water.

### SUMMARY

A potted cavity fitting is disclosed herein. The potted cavity fitting includes a fitting, a first cavity, and a second cavity. The fitting is configured to receive an end of a tube and a portion from the end of the tube. The first cavity is configured within the fitting. The first cavity so configured to retain a first mechanism the prevent or reduce liquid from passing through. The second cavity configured within the fitting. The second cavity is configured to retain a second mechanism at least one of coupled to or formed within the tube.

In various embodiments, the tube is comprised of at least one of polyethylene (PE), polypropylene (PP), polyester, polyoxymethylene (POM), polyamide (PA), polyarylene sulfide, polyketone (PK), polyetherketone (PEK), polyether ether ketone (PEEK), polyether ketone (PEKK), polyvinylidene fluoride (PVDF), polytetrafluoroethylene (PTFE), polyaryletherketone (PAEK), polyether nitrile (PEN), fluororesin, or liquid crystal polymer (LCP).

In various embodiments, the fitting is comprised of at least one of stainless steel, aluminum, or titanium.

In various embodiments, the first mechanism is at least one of an elastomeric seal or a sealant. In various embodiments, the elastomeric seal is at least one of an elastomeric X-ring seal or an elastomeric O-ring seal. In various embodiments, the sealant is at least one of a polysulfide, silicone, fluorosilocone, fluorocarbon, polytetrafluoroethylene, polyurethane, ethylene propylene diene monomer (EPDM) rubber, nitrile rubber, polybutadiene rubber, polyisoprene rubber, or polystyrene-butadiene rubber.

In various embodiments, the first cavity is filled with the sealant via a first fill hole on an exterior of the fitting.

In various embodiments, the portion from the end of the tube is prepared for adhesion to the second mechanism. In various embodiments, the preparation for adhesion comprises at least one of application of a primer or etchant, lasered with an ultraviolet (UV) laser, or application of a plasma/corona treatment.

In various embodiments, the second mechanism is at least one of an adhesive or an injection molded plastic. In various embodiments, the at least one of the adhesive or the injection molded plastic bonds to the portion from the end of the tube inserted into the fitting.

In various embodiments, the second cavity is filled with the at least one of the adhesive or the injection molded plastic via a second fill hole on the fitting. In various embodiments, the second fill hole is either on an exterior side of the fitting or on an end of the fitting.

In various embodiments, the second cavity of the fitting is coated with at least one of paint, mold release, or grease to ensure that a bond between the fitting and the at least one of the adhesive or the injection molded plastic is weaker than a bond between the portion from the end of the tube and the at least one of the adhesive or the injection molded plastic.

In various embodiments, the second mechanism is a thermoformed bump formed in the tube.

Also disclosed herein is an aircraft. The aircraft includes a potted cavity fitting. The potted cavity fitting includes a fitting, a first cavity, and a second cavity. The fitting is configured to receive an end of a tube and a portion from the end of the tube. The first cavity is configured within the fitting. The first cavity so configured to retain a first mechanism the prevent or reduce liquid from passing through. The second cavity configured within the fitting. The second cavity is configured to retain a second mechanism at least one of coupled to or formed within the tube.

In various embodiments, the tube is comprised of at least one of polyethylene (PE), polypropylene (PP), polyester, polyoxymethylene (POM), polyamide (PA), polyarylene sulfide, polyketone (PK), polyetherketone (PEK), polyether ether ketone (PEEK), polyether ketone (PEKK), polyvinylidene fluoride (PVDF), polytetrafluoroethylene (PTFE), polyaryletherketone (PAEK), polyether nitrile (PEN), fluororesin, or liquid crystal polymer (LCP).

In various embodiments, the fitting is comprised of at least one of stainless steel, aluminum, or titanium.

In various embodiments, the first mechanism is at least one of an elastomeric seal or a sealant. In various embodiments, the elastomeric seal is at least one of an elastomeric X-ring seal or an elastomeric O-ring seal. In various embodiments, the sealant is at least one of a polysulfide, silicone, fluorosilocone, fluorocarbon, polytetrafluoroethylene, polyurethane, ethylene propylene diene monomer (EPDM) rubber, nitrile rubber, polybutadiene rubber, polyisoprene rubber, or polystyrene-butadiene rubber.

In various embodiments, the first cavity is filled with the sealant via a first fill hole on an exterior of the fitting.

In various embodiments, the portion from the end of the tube is prepared for adhesion to the second mechanism. In various embodiments, the preparation for adhesion comprises at least one of application of a primer or etchant, lasered with an ultraviolet (UV) laser, or application of a plasma/corona treatment.

In various embodiments, the second mechanism is at least one of an adhesive or an injection molded plastic. In various embodiments, the at least one of the adhesive or the injection molded plastic bonds to the portion from the end of the tube inserted into the fitting.

In various embodiments, the second cavity is filled with the at least one of the adhesive or the injection molded plastic via a second fill hole on the fitting. In various embodiments, the second fill hole is either on an exterior side of the fitting or on an end of the fitting.

In various embodiments, the second cavity of the fitting is coated with at least one of paint, mold release, or grease to ensure that a bond between the fitting and the at least one of the adhesive or the injection molded plastic is weaker than a bond between the portion from the end of the tube and the at least one of the adhesive or the injection molded plastic.

In various embodiments, the second mechanism is a thermoformed bump formed in the tube.

The present disclosure may include any one or more of the individual features disclosed above and/or below alone or in any combination thereof. The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures, wherein like numerals denote like elements.

FIGS. 1A and 1B illustrate a cross sectional view and an isometric cross-sectional view of a potted cavity fitting, in accordance with various embodiments.

FIGS. 2A and 2B illustrate a cross sectional view and an isometric cross-sectional view of a potted cavity fitting, in accordance with various embodiments.

FIGS. 3A and 3B illustrate a cross sectional view and an isometric cross-sectional view of a potted cavity fitting, in accordance with various embodiments.

FIGS. 4A and 4B illustrate a top view and an isometric view of a fill void, in accordance with various embodiments.

FIGS. 5A, 5B, and 5C illustrate an end view, a cross sectional view, and an isometric sectional view of a potted cavity fitting, in accordance with various embodiments.

FIGS. 6A and 6B illustrate a cross sectional view, and an isometric cross-sectional view of a potted cavity fitting, in accordance with various embodiments.

FIGS. 7A and 7B illustrate a cross sectional view and an isometric cross-sectional view of a potted cavity fitting, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosure, it should be understood that other embodiments may be realized and that logical changes and adaptations in design and construction may be made in accordance with this disclosure and the teachings herein. Thus, the detailed description herein is presented for purposes of illustration only and not of limitation. The scope of the disclosure is defined by the appended claims. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an,” or “the” may include one or more than one and that reference to an item in the singular may also include the item in the plural. Further, all ranges may include upper and lower values and all ranges and ratio limits disclosed herein may be combined.

As stated previously, typical metallic fittings utilized in aircrafts are designed for high strength and low creep of the metals utilized in the fittings. While plastic tubing is lighter and less expensive than metallic tubing, plastic tubing does not have a strength or creep resistance to be formed so as to interface with standard metallic fittings. Moreover, because of differing coefficients of thermal expansion (CTE), plastic and metal tubing may not be directly bonded together because the bond may be subject to stresses greater than the strength of most adhesives. Furthermore, most adhesives are not approved for use with potable water and may contaminate the water.

Disclosed herein is a potted cavity fitting for use in an aircraft. In various embodiments, a flexible seal for potable water tubing is utilized along with an adhesive in a cavity of the metallic fitting. In various embodiments, an area of the plastic tubing where the metallic fitting will be fitted is prepared for adhesive. In various embodiments, the preparation may include application of a primer or etchant, lasered with an ultraviolet (UV) laser, or application of a plasma/corona treatment, among others. In various embodiments, the metallic fitting that is to be coupled to the plastic tubing requires no preparation for the adhesive. In that regard, in various embodiments, areas of the metallic fitting that will contact the plastic tubing may be coated with paint, mold release, or grease to ensure that a bond between the metallic fitting and the plastic and adhesive is weaker than the bond between the plastic and the adhesive. In various embodiments, the metallic fitting is fitted onto the plastic tubing and then the cavity within the metallic fitting is configured to be filled with the adhesive, which adheres to the prepared area of the plastic tubing. In various embodiments, because the seal is flexible and the geometry of the cavity of the metallic fitting locks the metallic fitting in place, the adhesive may not fully adhere to the metallic interior of the cavity and therefore is not subject to high stresses from CTE mismatch.

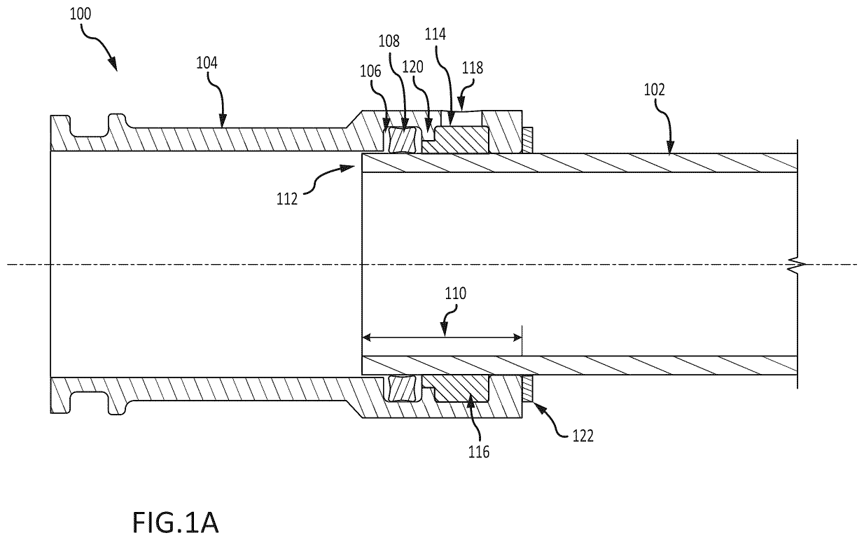

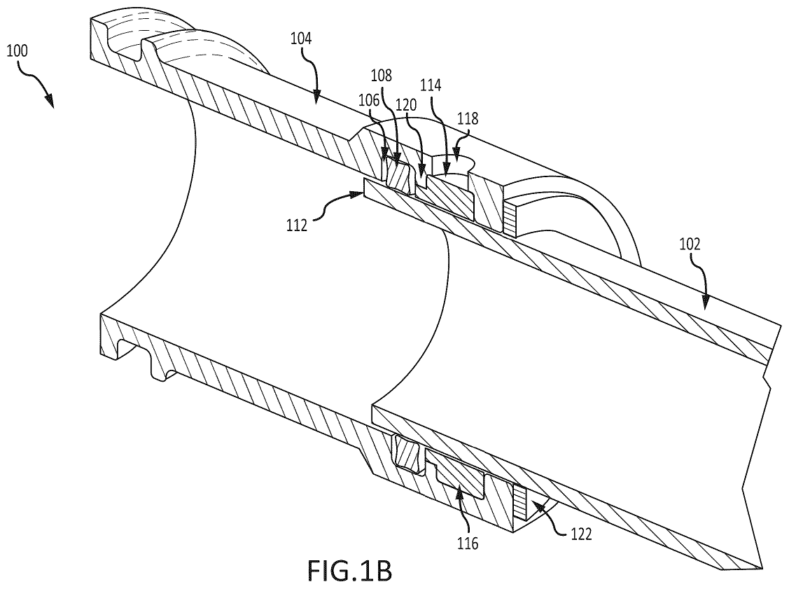

Referring to FIGS. 1A and 1B, in accordance with various embodiments, a cross sectional view and an isometric cross-sectional view of a potted cavity fitting 100 is illustrated. In various embodiments, the potted cavity fitting 100 includes a tube 102 and a fitting 104. In various embodiments, the tube 102 may be comprised of polyethylene (PE), polypropylene (PP), polyester, polyoxymethylene (POM), polyamide (PA), polyarylene sulfide, polyketone (PK), polyetherketone (PEK), polyether ether ketone (PEEK), polyether ketone (PEKK), polyvinylidene fluoride (PVDF), polytetrafluoroethylene (PTFE), polyaryletherketone (PAEK), polyether nitrile (PEN), fluororesin, or liquid crystal polymer (LCP), among others. In various embodiments, the fitting 104 may be comprised of stainless steel, aluminum, or titanium, among other materials. In various embodiments, the fitting 104 includes a first cavity 106, i.e. a groove, formed on an inside circumference of the fitting 104 to house an elastomeric seal 108 is configured to prevent or reduce liquid from passing through. In various embodiments, the elastomeric seal 108 may be an elastomeric X-ring seal or an elastomeric O-ring seal.

In various embodiments, an exterior of a portion 110 of the tube 102 to be inserted into the fitting 104 is prepared for adhesive or an injection molded plastic. In various embodiments, the preparation may include application of a primer or etchant, lasered with an ultraviolet (UV) laser, or application of a plasma/corona treatment, among others. In various embodiments, areas of the fitting 104 that will contact an adhesive 116 or the injection molded plastic, described hereafter, may be coated with paint, mold release, or grease to ensure that a bond between the fitting 104 and the adhesive or the injection molded plastic is weaker than the bond between the tube 102 and the adhesive or the injection molded plastic. Once prepared, in various embodiments, a tube end 112 along with the portion 110 of the tube 102 is configured to be inserted into the fitting 104. In various embodiments, the fitting 104 is shoulderless on an inside of the fitting 104. In that regard, in various embodiments, the portion 110 of the tube 102 that is to be inserted into the fitting 104 may be controlled externally by the person inserting the tube 102 into the fitting 104 during assembly.

In various embodiments, once the portion 110 of the tube 102 is inserted into the fitting 104, a second cavity 114, i.e. a groove, formed on an inside circumference of the fitting 104 adjacent to the first cavity 106 and positioned nearer the outer end of the fitting 104 is configured to be filled with the adhesive 116, such as a resin, or the injection molded plastic similar to the material used to form tube 102, via fill void 118 that provides access to the second cavity 114 from an exterior of the fitting 104. In various embodiments, the adhesive 116 or the injection molded plastic adheres to the prepared area of the tube 102. In various embodiments, a divider 120 between the first cavity 106 and the second cavity 114 may extend circumferentially inward such that the divider 120 contacts or substantially contacts the tube 102. In various embodiments, the divider 120 between the first cavity 106 and the second cavity 114 may extend circumferentially inward such that the divider 120 is a distance away from contacting the tube 102, thereby allowing the adhesive 116 or the injection molded plastic to fill a gap between the radially inward end of the divider 120 and the tube 102. In various embodiments, a temporary seal 122 may be temporarily affixed to an outer end of the fitting 104 to prevent the adhesive 116 or the injection molded plastic from leaking out of the fitting 104 when the second cavity 114 is filled with the adhesive 116 or the injection molded plastic. In various embodiments, once the second cavity 114 is filled with the adhesive 116 or the injection molded plastic, the adhesive 116 or the injection molded plastic is allowed to cure. In various embodiments, once the adhesive 116 or the injection molded plastic has cured, the temporary seal 122 may be removed.

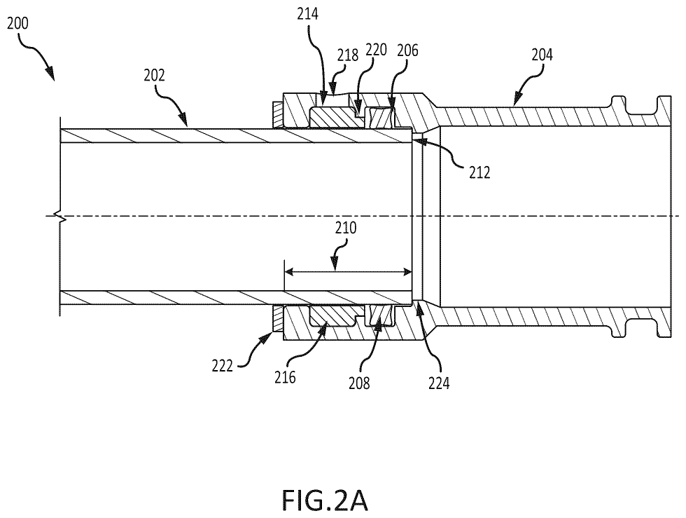

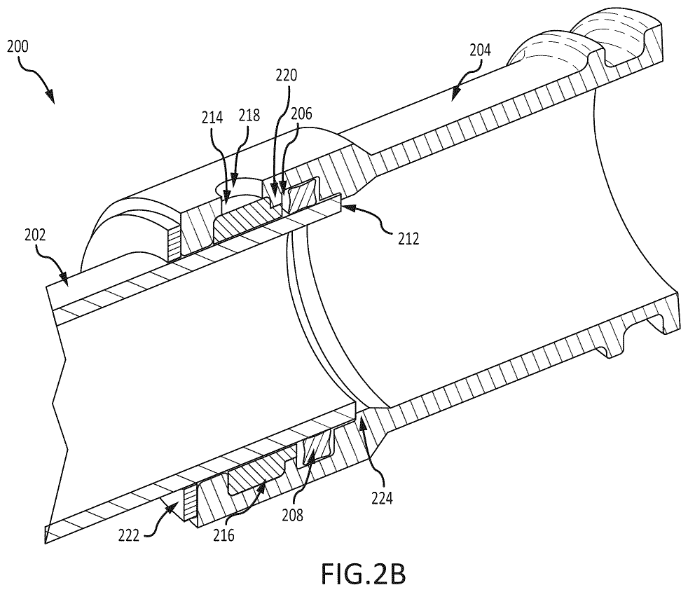

Referring to FIGS. 2A and 2B, in accordance with various embodiments, a cross sectional view and an isometric cross-sectional view of a potted cavity fitting 200 is illustrated. In various embodiments, the potted cavity fitting 200 includes a tube 202 and a fitting 204. In various embodiments, the tube 202 may be comprised of polyethylene (PE), polypropylene (PP), polyester, polyoxymethylene (POM), polyamide (PA), polyarylene sulfide, polyketone (PK), polyetherketone (PEK), polyether ether ketone (PEEK), polyether ketone (PEKK), polyvinylidene fluoride (PVDF), polytetrafluoroethylene (PTFE), polyaryletherketone (PAEK), polyether nitrile (PEN), fluororesin, or liquid crystal polymer (LCP), among others. In various embodiments, the fitting 204 may be comprised of stainless steel, aluminum, or titanium, among other materials. In various embodiments, the fitting 204 includes a first cavity 206, i.e. a groove, formed on an inside circumference of the fitting 204 to house an elastomeric seal 208 is configured to prevent or reduce liquid from passing through. In various embodiments, the elastomeric seal 208 may be an elastomeric X-ring seal or an elastomeric O-ring seal.

In various embodiments, an exterior of a portion 210 of the tube 202 to be inserted into the fitting 204 is prepared for adhesive or an injection molded plastic. In various embodiments, the preparation may include application of a primer or etchant, lasered with an ultraviolet (UV) laser, or application of a plasma/corona treatment, among others. In various embodiments, areas of the fitting 204 that will contact an adhesive 216 or the injection molded plastic, described hereafter, may be coated with paint, mold release, or grease to ensure that a bond between the fitting 204 and the adhesive or the injection molded plastic is weaker than the bond between the tube 202 and the adhesive or the injection molded plastic. Once prepared, in various embodiments, a tube end 212 along with the portion 210 of the tube 202 is configured to be inserted into the fitting 204. In difference to FIGS. 1A and 1B, in various embodiments, the fitting 204 is configured with a shoulder 224 on an inside of the fitting 204. In that regard, in various embodiments, the portion 210 of the tube 202 that is to be inserted into the fitting 204 is controlled internally by the shoulder 224 of the fitting 204 during assembly.

In various embodiments, once the portion 210 of the tube 202 is inserted into the fitting 204, a second cavity 214, i.e. a groove, formed on an inside circumference of the fitting 204 adjacent to the first cavity 206 and positioned nearer the outer end of the fitting 204 is configured to be filled with the adhesive 216, such as a resin, or the injection molded plastic similar to the material used to form tube 202, via fill void 218 that provides access to the second cavity 214 from an exterior of the fitting 204. In various embodiments, the adhesive 216 or the injection molded plastic adheres to the prepared area of the tube 202. In various embodiments, a divider 220 between the first cavity 206 and the second cavity 214 may extend circumferentially inward such that the divider 220 contacts or substantially contacts the tube 202. In various embodiments, the divider 220 between the first cavity 206 and the second cavity 214 may extend circumferentially inward such that the divider 220 is a distance away from contacting the tube 202, thereby allowing the adhesive 216 or the injection molded plastic to fill a gap between the radially inward end of the divider 220 and the tube 202. In various embodiments, a temporary seal 222 may be temporarily affixed to an outer end of the fitting 204 to prevent the adhesive 216 or the injection molded plastic from leaking out of the fitting 204 when the second cavity 214 is filled with the adhesive 216 or the injection molded plastic. In various embodiments, once the second cavity 214 is filled with the adhesive 216 or the injection molded plastic, the adhesive 216 or the injection molded plastic is allowed to cure. In various embodiments, once the adhesive 216 or the injection molded plastic has cured, the temporary seal 222 may be removed.

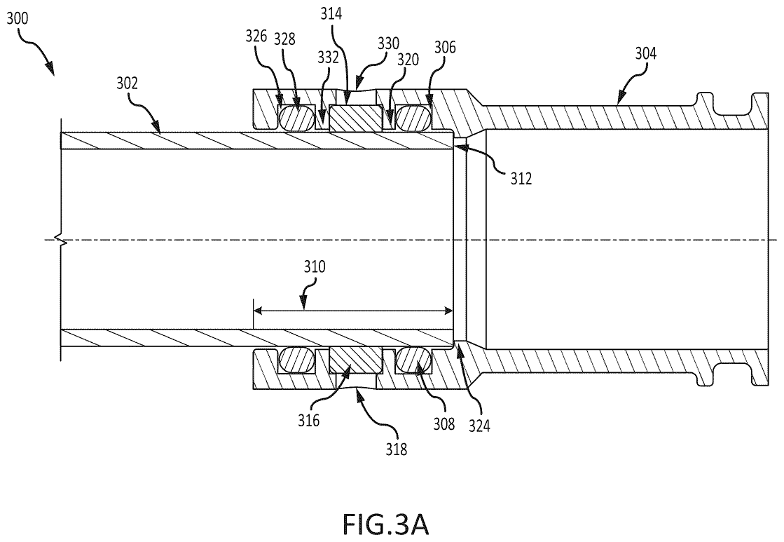

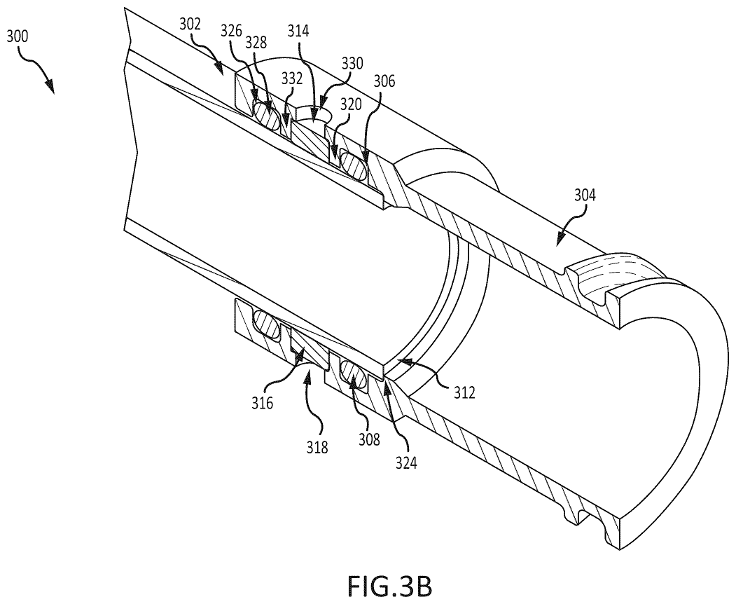

Referring to FIGS. 3A and 3B, in accordance with various embodiments, a cross sectional view and an isometric cross-sectional view of a potted cavity fitting 300 is illustrated. In various embodiments, the potted cavity fitting 300 includes a tube 302 and a fitting 304. In various embodiments, the tube 302 may be comprised of polyethylene (PE), polypropylene (PP), polyester, polyoxymethylene (POM), polyamide (PA), polyarylene sulfide, polyketone (PK), polyetherketone (PEK), polyether ether ketone (PEEK), polyether ketone (PEKK), polyvinylidene fluoride (PVDF), polytetrafluoroethylene (PTFE), polyaryletherketone (PAEK), polyether nitrile (PEN), fluororesin, or liquid crystal polymer (LCP), among others. In various embodiments, the fitting 304 may be comprised of stainless steel, aluminum, or titanium, among other materials.

In various embodiments, the fitting 304 includes a first cavity 306, i.e. a groove, formed on an inside circumference of the fitting 304 to house an elastomeric seal 308 is configured to prevent or reduce liquid from passing through. In various embodiments, the elastomeric seal 308 may be an elastomeric X-ring seal or an elastomeric O-ring seal. In various embodiments, the fitting 304 includes a second cavity 326, i.e. a groove, formed on an inside circumference of the fitting 304 to house an elastomeric seal 328 is configured to prevent or reduce liquid from passing through. In various embodiments, the elastomeric seal 328 may be an elastomeric X-ring seal or an elastomeric O-ring seal. In various embodiments, the second cavity 326 is positioned nearer the outer end of the fitting 304 than the first cavity 306. In various embodiments, an exterior of a portion 310 of the tube 302 to be inserted into the fitting 304 is prepared for adhesive or an injection molded plastic. In various embodiments, the preparation may include the application of a primer or etchant, lasered with an ultraviolet (UV) laser, or application of a plasma/corona treatment, among others. In various embodiments, areas of the fitting 304 that will contact an adhesive 316 or the injection molded plastic, described hereafter, may be coated with paint, mold release, or grease to ensure that a bond between the fitting 304 and an adhesive or the injection molded plastic is weaker than the bond between the tube 302 and the adhesive or the injection molded plastic. Once prepared, in various embodiments, a tube end 312 along with the portion 310 of the tube 302 is configured to be inserted into the fitting 304. In various embodiments, the fitting 304 is configured with a shoulder 324 on an inside of the fitting 304. In that regard, in various embodiments, the portion 310 of the tube 302 that is to be inserted into the fitting 304 is controlled internally by the shoulder 324 of the fitting 304 during assembly. In various embodiments, the fitting 304 may be shoulderless on an inside of the fitting 304. In that regard, in various embodiments, the portion 310 of the tube 302 that is to be inserted into the fitting 304 may be controlled externally by the person inserting the tube 302 into the fitting 304 during assembly.

In various embodiments, once the portion 310 of the tube 302 is inserted into the fitting 304, a third cavity 314, i.e. a groove, formed on an inside circumference of the fitting 304 between the first cavity 306 and the second cavity 326 is configured to be filled with the adhesive 316, such as a resin, or the injection molded plastic similar to the material used to form tube 302, via fill void 318 that provides access to the third cavity 314 from an exterior of the fitting 304. In various embodiments, a gas escape void 330 is provided in the fitting opposite fill void 318. In that regard, due to the presence of the elastomeric seal 308 and the elastomeric seal 328, gasses in the third cavity 314 require venting due to the filling of the third cavity 314 by the adhesive 316 or the injection molded plastic. In various embodiments, the gas escape void 330 may be a passive gas escape void, were gasses vent on their own. In various embodiments, the gas escape void 330 may be an active gas escape void, were gasses are vented via a vacuum coupled to the gas escape void 330.

In various embodiments, the adhesive 316 or the injection molded plastic adheres to the prepared area of the tube 302. In various embodiments, a divider 320 between the first cavity 306 and the third cavity 314 may extend circumferentially inward such that the divider 320 contacts or substantially contacts the tube 302. In various embodiments, the divider 320 between the first cavity 306 and the third cavity 314 may extend circumferentially inward such that the divider 320 is a distance away from contacting the tube 302, thereby allowing the adhesive 316 or the injection molded plastic to fill a gap between the radially inward end of the divider 320 and the tube 302. In various embodiments, a divider 332 between the second cavity 326 and the third cavity 314 may extend circumferentially inward such that the divider 332 contacts or substantially contacts the tube 302. In various embodiments, the divider 332 between the second cavity 326 and the third cavity 314 may extend circumferentially inward such that the divider 332 is a distance away from contacting the tube 302, thereby allowing the adhesive 316 or the injection molded plastic to fill a gap between the radially inward end of the divider 332 and the tube 302. In various embodiments, once the third cavity 314 is filled with the adhesive 316 or the injection molded plastic, the adhesive 316 or the injection molded plastic is allowed to cure.

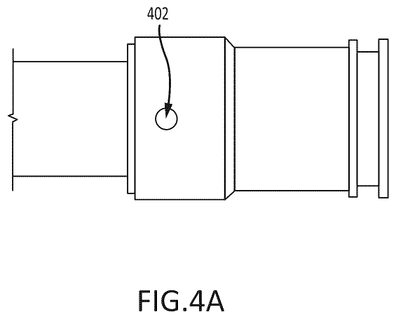

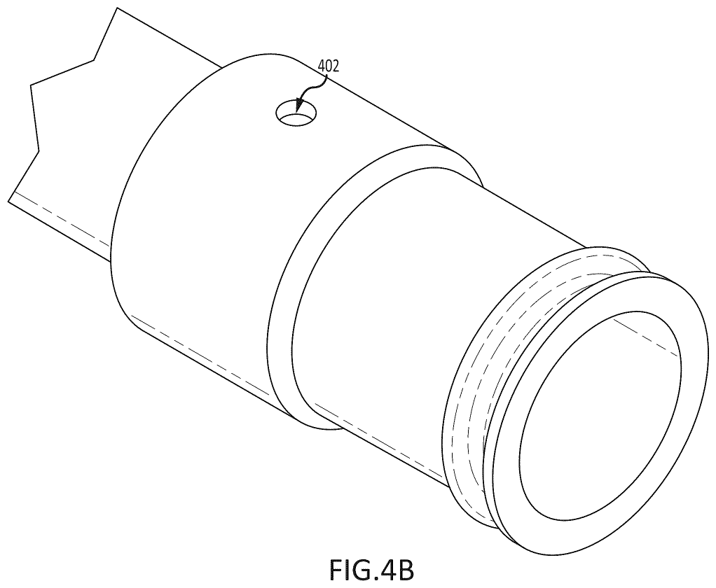

Referring to FIGS. 4A and 4B, in accordance with various embodiments, a top view and an isometric view of a fill void is illustrated. In various embodiments, fill void 402 may be a fill void such as fill void 118 of FIGS. 1A and 1B, fill void 218 of FIGS. 2A and 2B, or fill void 318 of FIGS. 3A and 3B. In various embodiments, fill void 402 may be representative of gas escape void 330 of FIGS. 3A and 3B.

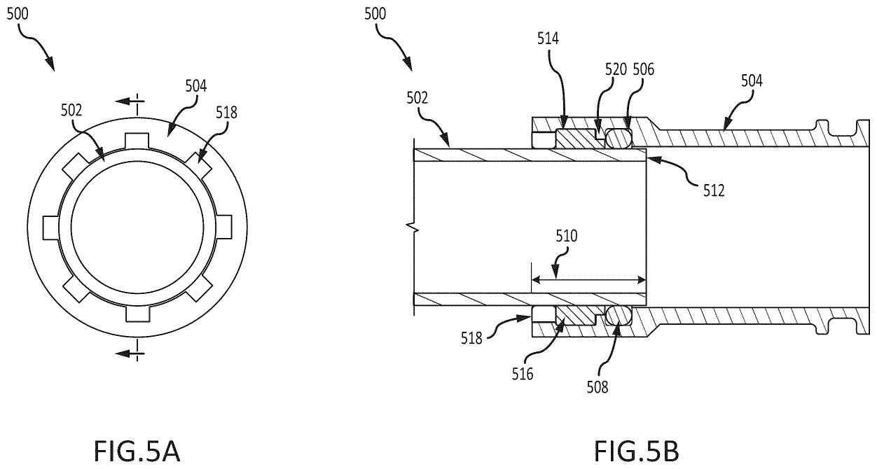

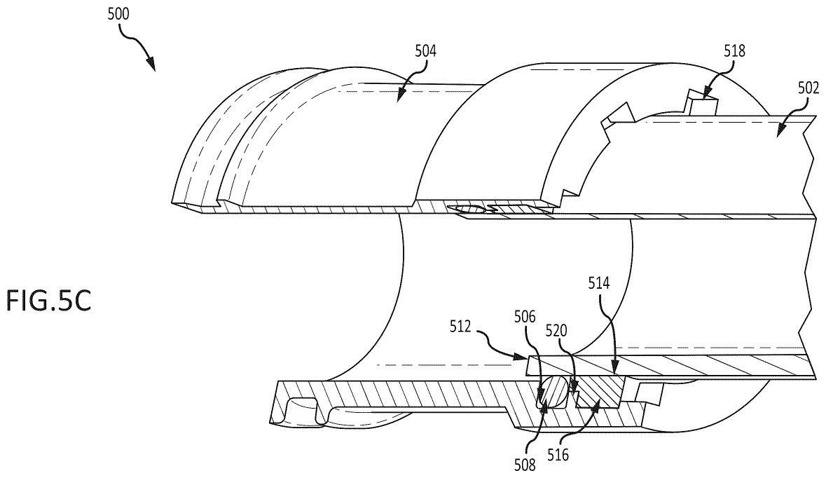

Referring to FIGS. 5A, 5B, and 5C, in accordance with various embodiments, an end view, a cross sectional view, and an isometric sectional view of a potted cavity fitting 500 is illustrated. In various embodiments, the potted cavity fitting 500 includes a tube 502 and a fitting 504. In various embodiments, the tube 502 may be comprised of polyethylene (PE), polypropylene (PP), polyester, polyoxymethylene (POM), polyamide (PA), polyarylene sulfide, polyketone (PK), polyetherketone (PEK), polyether ether ketone (PEEK), polyether ketone (PEKK), polyvinylidene fluoride (PVDF), polytetrafluoroethylene (PTFE), polyaryletherketone (PAEK), polyether nitrile (PEN), fluororesin, or liquid crystal polymer (LCP), among others. In various embodiments, the fitting 504 may be comprised of stainless steel, aluminum, or titanium, among other materials. In various embodiments, the fitting 504 includes a first cavity 506, i.e. a groove, formed on an inside circumference of the fitting 504 to house an elastomeric seal 508 is configured to prevent or reduce liquid from passing through. In various embodiments, the elastomeric seal 508 may be an elastomeric X-ring seal or an elastomeric O-ring seal.

In various embodiments, an exterior of a portion 510 of the tube 502 to be inserted into the fitting 504 is prepared for adhesive or an injection molded plastic. In various embodiments, the preparation may include application of a primer or etchant, lasered with an ultraviolet (UV) laser, or application of a plasma/corona treatment, among others. In various embodiments, areas of the fitting 504 that will contact an adhesive 516 or the injection molded plastic, described hereafter, may be coated with paint, mold release, or grease to ensure that a bond between the fitting 504 and the adhesive or the injection molded plastic is weaker than the bond between the tube 502 and the adhesive or the injection molded plastic. Once prepared, in various embodiments, a tube end 512 along with the portion 510 of the tube 202 is configured to be inserted into the fitting 504. In various embodiments, the fitting 504 is shoulderless on an inside of the fitting 504. In that regard, in various embodiments, the portion 510 of the tube 502 that is to be inserted into the fitting 504 may be controlled externally by the person inserting the tube 502 into the fitting 504 during assembly. In various embodiments, the fitting 504 may be configured with a shoulder, similar to shoulder 224 of FIGS. 2A and 2B, on an inside of the fitting 504. In that regard, in various embodiments, the portion 510 of the tube 502 that is to be inserted into the fitting 504 may be controlled internally by the shoulder of the fitting 504 during assembly.

In various embodiments, once the portion 510 of the tube 502 is inserted into the fitting 504, a second cavity 514, i.e. a groove, formed on an inside circumference of the fitting 504 adjacent to the first cavity 506 and positioned nearer the outer end of the fitting 504 is configured to be filled with the adhesive 516, such as a resin, or the injection molded plastic similar to the material used to form tube 502, via fill void 518 that provides access to the second cavity 514 from an end of the fitting 504 that the tube 502 was inserted. In various embodiments, the adhesive 516 or the injection molded plastic adheres to the prepared area of the tube 502. In various embodiments, a divider 520 between the first cavity 506 and the second cavity 514 may extend circumferentially inward such that the divider 520 contacts or substantially contacts the tube 502. In various embodiments, the divider 520 between the first cavity 506 and the second cavity 514 may extend circumferentially inward such that the divider 520 is a distance away from contacting the tube 502, thereby allowing the adhesive 516 or the injection molded plastic to fill a gap between the radially inward end of the divider 520 and the tube 502. In various embodiments, once the second cavity 514 is filled with the adhesive 516 or the injection molded plastic, the adhesive 516 or the injection molded plastic is allowed to cure.

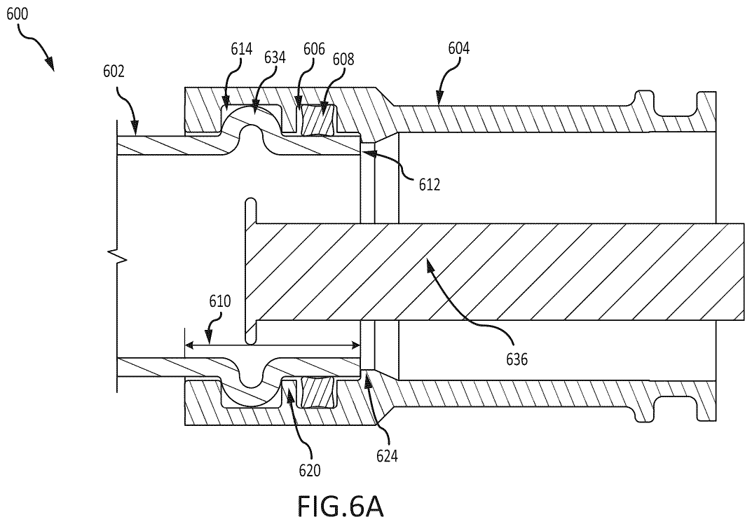

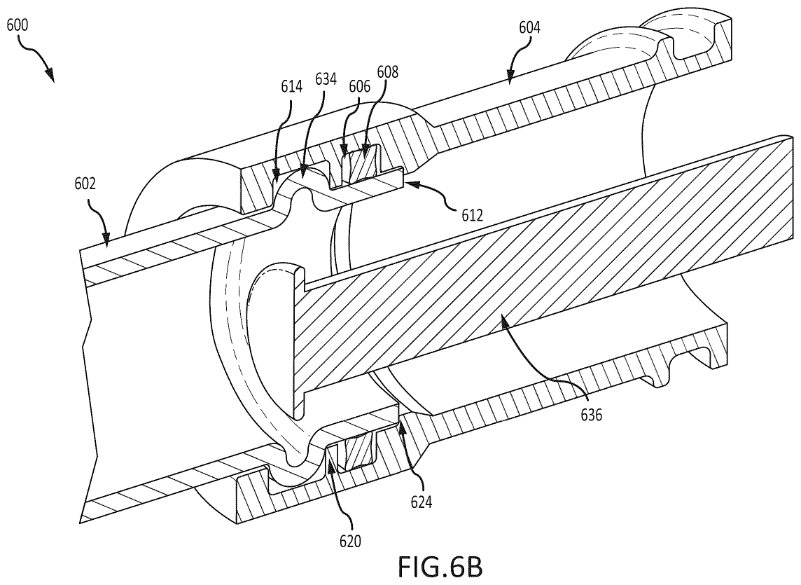

Referring to FIGS. 6A and 6B, in accordance with various embodiments, a cross sectional view and an isometric cross-sectional view of a potted cavity fitting 600 is illustrated. In various embodiments, the potted cavity fitting 600 includes a tube 602 and a fitting 604. In various embodiments, the tube 602 may be comprised of polyethylene (PE), polypropylene (PP), polyester, polyoxymethylene (POM), polyamide (PA), polyarylene sulfide, polyketone (PK), polyetherketone (PEK), polyether ether ketone (PEEK), polyether ketone (PEKK), polyvinylidene fluoride (PVDF), polytetrafluoroethylene (PTFE), polyaryletherketone (PAEK), polyether nitrile (PEN), fluororesin, or liquid crystal polymer (LCP), among others. In various embodiments, the fitting 604 may be comprised of stainless steel, aluminum, or titanium, among other materials. In various embodiments, the fitting 604 includes a first cavity 606, i.e. a groove, formed on an inside circumference of the fitting 604 to house an elastomeric seal 608 is configured to prevent or reduce liquid from passing through. In various embodiments, the elastomeric seal 608 may be an elastomeric X-ring seal or an elastomeric O-ring seal.

In various embodiments, a tube end 612 along with a portion 610 of the tube 602 is configured to be inserted into the fitting 604. In various embodiments, the fitting 604 may be configured with a shoulder 624 on an inside of the fitting 604. In that regard, in various embodiments, the portion 610 of the tube 602 that is to be inserted into the fitting 604 may be controlled internally by the shoulder 624 of the fitting 604 during assembly. In various embodiments, the fitting 604 may be shoulderless on an inside of the fitting 604. In that regard, in various embodiments, the portion 610 of the tube 602 that is to be inserted into the fitting 604 may be controlled externally by the person inserting the tube 602 into the fitting 604 during assembly.

In various embodiments, once the portion 610 of the tube 602 is inserted into the fitting 604, a second cavity 614, i.e. a groove, formed on an inside circumference of the fitting 604 adjacent to the first cavity 606 and positioned nearer the outer end of the fitting 604 is configured to be filled by forming a thermoformed bump 634 in the tube 602. In that regard, a thermoforming tool 636 may be inserted through the fitting 604 and manipulated to form the thermoformed bump 634 in the tube 602 that fills the second cavity 614. In various embodiments, a divider 620 between the first cavity 606 and the second cavity 614 may extend circumferentially inward such that the divider 620 contacts or substantially contacts the tube 602. In various embodiments, the thermoformed bump 634 may be formed such that the outer portions of the thermoformed bump 634 contact the walls of the second cavity 614.

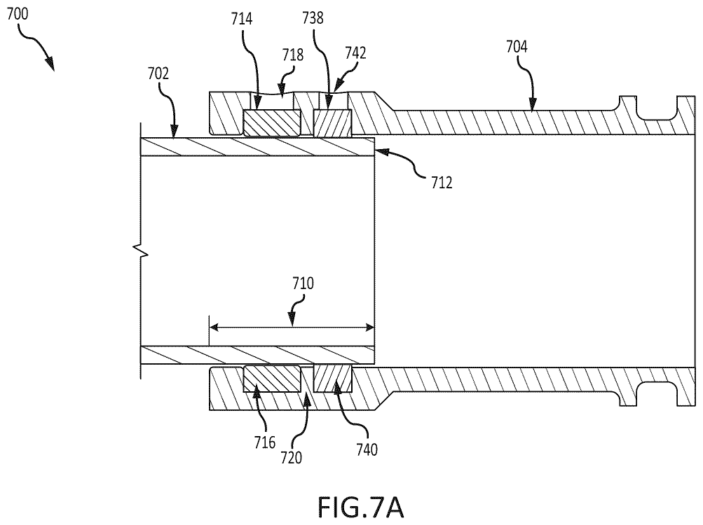

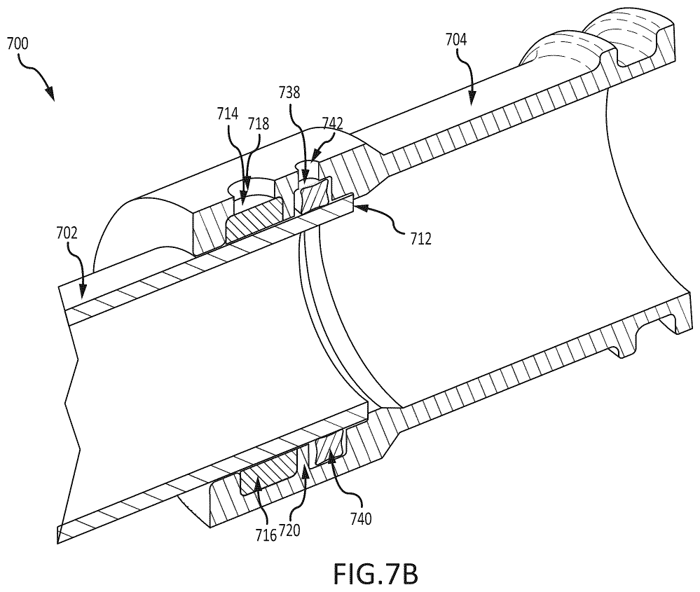

Referring to FIGS. 7A and 7B, in accordance with various embodiments, a cross sectional view and an isometric cross-sectional view of a potted cavity fitting 700 is illustrated. In various embodiments, the potted cavity fitting 700 includes a tube 702 and a fitting 704. In various embodiments, the tube 702 may be comprised of polyethylene (PE), polypropylene (PP), polyester, polyoxymethylene (POM), polyamide (PA), polyarylene sulfide, polyketone (PK), polyetherketone (PEK), polyether ether ketone (PEEK), polyether ketone (PEKK), polyvinylidene fluoride (PVDF), polytetrafluoroethylene (PTFE), polyaryletherketone (PAEK), polyether nitrile (PEN), fluororesin, or liquid crystal polymer (LCP), among others. In various embodiments, the fitting 704 may be comprised of stainless steel, aluminum, or titanium, among other materials.

In various embodiments, an exterior of a portion 710 of the tube 702 to be inserted into the fitting 104 is prepared for adhesive or the injection molded plastic. In various embodiments, surfaces of cavity 738 in fitting 704 may be prepared for an adhesive 716 or an injection molded plastic. In various embodiments, the preparations may include application of a primer or etchant, lasered with an ultraviolet (UV) laser, or application of a plasma/corona treatment, among others. In various embodiments, areas of the fitting 704 that will contact the adhesive 716 or the injection molded sealant, described hereafter, may be coated with paint, mold release, or grease to ensure that a bond between the fitting 704 and the adhesive or the injection molded plastic is weaker than the bond between the tube 702 and the adhesive or the injection molded plastic. Once prepared, in various embodiments, a tube end 712 along with the portion 710 of the tube 702 is configured to be inserted into the fitting 704. In various embodiments, the fitting 704 is shoulderless on an inside of the fitting 704. In that regard, in various embodiments, the portion 710 of the tube 702 that is to be inserted into the fitting 704 may be controlled externally by the person inserting the tube 702 into the fitting 704 during assembly. In various embodiments, the fitting 704 may be configured with a shoulder, similar to shoulder 224 of FIGS. 2A and 2B, on an inside of the fitting 704. In that regard, in various embodiments, the portion 710 of the tube 702 that is to be inserted into the fitting 704 may be controlled internally by the shoulder of the fitting 704 during assembly.

In various embodiments, the fitting 704 includes a first cavity 738, i.e. a groove, formed on an inside circumference of the fitting 704. In various embodiments, once the portion 710 of the tube 702 is inserted into the fitting 704, the first cavity 738 may be filled with a sealant 740 via fill void 742 that provides access to the first cavity 738 from an exterior of the fitting 704. In various embodiments, the sealant 740 may be at least one of a polysulfide, silicone, fluorosilocone, fluorocarbon, polytetrafluoroethylene, polyurethane, ethylene propylene diene monomer (EPDM) rubber, nitrile rubber, polybutadiene rubber, polyisoprene rubber, or polystyrene-butadiene rubber, among others. In various embodiments, the sealant 740 is configured to prevent or reduce liquid from passing through. Additionally, in various embodiments, once the portion 710 of the tube 702 is inserted into the fitting 704, a second cavity 714, i.e. a groove, formed on an inside circumference of the fitting 704 adjacent to the first cavity 738 and positioned nearer the outer end of the fitting 704 is configured to be filled with the adhesive 716, such as a resin, or the injection molded plastic similar to the material used to form tube 702, via fill void 718 that provides access to the second cavity 714 from an exterior of the fitting 704. In various embodiments, the adhesive 716 or the injection molded plastic adheres to the prepared area of the tube 102. In various embodiments, a divider 720 between the first cavity 738 and the second cavity 714 may extend circumferentially inward such that the divider 120 contacts or substantially contacts or substantially contacts the tube 102. In various embodiments, once the first cavity 738 is filled with the sealant 740 and once the second cavity 714 is filled with the adhesive 716 or the injection molded plastic, the sealant 740 and the adhesive 116 or the injection molded plastic are allowed to cure.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments,” “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A potted cavity fitting, the potted cavity fitting comprising:
a fitting configured to receive an end of a tube and a portion from the end of the tube;
a first cavity configured within the fitting, wherein the first cavity so configured to retain a first mechanism that prevents or reduces liquid from passing through, wherein the first mechanism is an elastomeric X-ring seal; and
a second cavity configured within the fitting, wherein the second cavity is configured to retain a second mechanism at least one of coupled to or formed within the tube.

2. The potted cavity fitting of claim 1, wherein the tube is comprised of at least one of polyethylene, polypropylene, polyester, polyoxymethylene, polyamide, polyarylene sulfide, polyketone, polyetherketone, polyether ether ketone, polyether ketone ketone, polyvinylidene fluoride, polytetrafluoroethylene, polyaryletherketone, polyether nitrile, fluororesin, or liquid crystal polymer.

3. The potted cavity fitting of claim 1, wherein the fitting is comprised of at least one of stainless steel, aluminum, or titanium.

4. The potted cavity fitting of claim 1, wherein the first mechanism further comprises a sealant, and wherein the sealant is at least one of a polysulfide, silicone, fluorosilocone, fluorocarbon, polytetrafluoroethylene, polyurethane, ethylene propylene diene monomer rubber, nitrile rubber, polybutadiene rubber, polyisoprene rubber, or polystyrene-butadiene rubber.

5. The potted cavity fitting of claim 4, wherein the first cavity is filled with the sealant via a first fill hole on an exterior of the fitting.

6. The potted cavity fitting of claim 1, wherein the portion from the end of the tube is prepared for adhesion to the second mechanism and wherein the preparation for adhesion comprises at least one of application of an etchant, lasered with an ultraviolet laser, or application of a plasma/corona treatment.

7. The potted cavity fitting of claim 1, wherein the second mechanism is an injection molded plastic and wherein the injection molded plastic bonds to the portion from the end of the tube inserted into the fitting.

8. The potted cavity fitting of claim 7, wherein the second cavity is filled with the injection molded plastic via a first fill hole on the fitting and wherein the first fill hole is either on an exterior side of the fitting or on an end of the fitting.

9. The potted cavity fitting of claim 7, wherein the second cavity of the fitting is coated with at least one of mold release or grease to ensure that a bond between the fitting and the injection molded plastic is weaker than a bond between the portion from the end of the tube and the injection molded plastic.

10. The potted cavity fitting of claim 1, wherein the second mechanism is a thermoformed bump formed in the tube.

11. An aircraft, the aircraft comprising:
a potted cavity fitting, the potted cavity fitting comprising:
a fitting configured to receive an end of a tube and a portion from the end of the tube;
a first cavity configured within the fitting, wherein the first cavity so configured to retain a first mechanism that prevents or reduces liquid from passing through, wherein the first mechanism is an elastomeric X-ring seal; and
a second cavity configured within the fitting, wherein the second cavity is configured to retain a second mechanism at least one of coupled to or formed within the tube.

12. The aircraft of claim 11, wherein the tube is comprised of at least one of polyethylene, polypropylene, polyester, polyoxymethylene, polyamide, polyarylene sulfide, polyketone, polyetherketone, polyether ether ketone, polyether ketone ketone, polyvinylidene fluoride, polytetrafluoroethylene, polyaryletherketone, polyether nitrile, fluororesin, or liquid crystal polymer.

13. The aircraft of claim 11, wherein the fitting is comprised of at least one of stainless steel, aluminum, or titanium.

14. The aircraft of claim 11, wherein the first mechanism further comprises a sealant, and wherein the sealant is at least one of a polysulfide, silicone, fluorosilocone, fluorocarbon, polytetrafluoroethylene, polyurethane, ethylene propylene diene monomer rubber, nitrile rubber, polybutadiene rubber, polyisoprene rubber, or polystyrene-butadiene rubber.

15. The aircraft of claim 14, wherein the first cavity is filled with the sealant via a first fill hole on an exterior of the fitting.

16. The aircraft of claim 11, wherein the portion from the end of the tube is prepared for adhesion to the second mechanism and wherein the preparation for adhesion comprises at least one of application of an etchant, lasered with an ultraviolet laser, or application of a plasma/corona treatment.

17. The aircraft of claim 11, wherein the second mechanism is an injection molded plastic and wherein the injection molded plastic bonds to the portion from the end of the tube inserted into the fitting.

18. The aircraft of claim 17, wherein the second cavity is filled with the injection molded plastic via a first fill hole on the fitting and wherein the first fill hole is either on an exterior side of the fitting or on an end of the fitting.

19. The aircraft of claim 17, wherein the second cavity of the fitting is coated with at least one of mold release or grease to ensure that a bond between the fitting and the injection molded plastic is weaker than a bond between the portion from the end of the tube and the injection molded plastic.

20. The aircraft of claim 11, wherein the second mechanism is a thermoformed bump formed in the tube.
